(19) United States
(12) Patent Application Publication
(10) Pub. No.: US 2026/0051423 A1
(43) Pub. Date: Feb. 19, 2026

(54) SUPERCONDUCTOR RIBBON CABLES WITH DOUBLE STRIPLINE STRUCTURES

(71) Applicant: International Business Machines Corporation, Armonk, NY (US)

(72) Inventors: Duixian Liu, Scarsdale, NY (US); Young Hoon Kwark, Chappaqua, NY (US)

(21) Appl. No.: 18/808,404

(22) Filed: Aug. 19, 2024

(51) Int. Cl. H01B 12/06; H01B 7/08; H01B 13/00

(52) U.S. Cl. CPC H01B 12/06; H01B 7/0807; H01B 13/0036

(57) ABSTRACT

One or more systems, devices and/or methods of fabrication provided herein relate to forming a superconductor ribbon cable structure with double stripline structures to improve flex yields. According to one embodiment, a superconductor ribbon cable structure can comprise a top ground plane and a bottom ground plane. In various embodiments, the superconductor ribbon cable structure can comprise a core substrate between the top ground plane and the bottom ground plane. In various aspects, the superconductor ribbon cable structure can comprise a double stripline structure in the core substrate. In various embodiments, the double stripline structure can comprise a first stripline and a second stripline, wherein the second stripline is a floating stripline.

### BACKGROUND

The subject disclosure relates to superconductor ribbon cables and, more specifically, to forming a superconductor ribbon cable with double stripline structures.

Superconductor cables, particularly superconductor flexible ribbon cables, are used in many electronic devices for high-speed signalling. More specifically, superconductor flexible ribbon cables provide efficient transmission of high-frequency signals with minimal signal loss by leveraging zero electrical resistance properties of superconducting materials. However, manufacturing processes for superconductor flexible ribbon cables are underdeveloped, resulting in lower yields of superconductor flexible ribbon cables, or lower proportions of fabricated superconductor flexible ribbon cables that meet functionality requirements. Particularly, superconductor flexible ribbon cables suffer defects to the channels within the superconductor flexible ribbon cables. Thus, systems and/or methods that can address this technical problem, and improve superconductor flexible ribbon cable yields, are needed.

The above-described background description is merely intended to provide a contextual overview regarding superconductor ribbon cable structures and is not intended to be exhaustive.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, superconductor ribbon cable structures with double stripline structures and methods to fabricate superconductor ribbon cable structures with double stripline structures are discussed.

According to an embodiment, a superconductor ribbon cable structure is provided. The superconductor ribbon cable structure can comprise a top ground plane and a bottom ground plane. The superconductor ribbon cable structure can further comprise a core substrate between the top ground plane and the bottom ground plane. The superconductor ribbon cable structure can further comprise a double stripline structure in the core substrate, the double stripline structure comprising a first stripline and a second stripline, wherein the second stripline is a floating stripline.

According to an embodiment, a superconductor ribbon cable structure is provided. The superconductor ribbon cable structure can comprise a top ground plane and a bottom ground plane. The superconductor ribbon cable structure can further comprise a substrate between the top ground plane and the bottom ground plane. The superconductor ribbon cable structure can further comprise a double stripline structure in the substrate, the double stripline structure comprising a first stripline and a second stripline, wherein the second stripline is a floating stripline. The double stripline structure can further comprise a connecting tab on each end of the double stripline structure that connects the first stripline.

According to an embodiment, a method is provided. The method can comprise creating a double stripline structure in a substrate, the double stripline structure comprising a first stripline and a second stripline that are connected at each end of the double stripline structure. The method can further comprise depositing a bottom ground plane on a bottom surface of the substrate. The method can further comprise disconnecting the first stripline or the second stripline in response to a defect in the first stripline or the second stripline. The method can further comprise depositing a top ground plane on a top surface of the substrate.

### BRIEF DESCRIPTION OF THE DRAWINGS

FIG. 1 illustrates an example, non-limiting cross-sectional view of a superconductor ribbon cable structure with a double stripline structure in accordance with one or more embodiments described herein.

FIG. 2 illustrates example, non-limiting double stripline structures and disconnecting a first stripline or a second stripline in accordance with one or more embodiments described herein.

FIG. 3 illustrates an example, non-limiting cross-sectional view of a superconductor ribbon cable structure with a double stripline structure in accordance with one or more embodiments described herein.

FIG. 4 illustrates an example, non-limiting top-down view of a superconductor ribbon cable structure with a double stripline structure in accordance with one or more embodiments described herein.

FIG. 5 illustrates an example, non-limiting top-down view of disconnecting a first stripline or a second stripline in a double stripline structure in accordance with one or more embodiments described herein.

FIG. 6 illustrates an example, non-limiting cross-sectional view of a superconductor ribbon cable structure with a double stripline structure comprising an up-down configuration in accordance with one or more embodiments described herein.

FIG. 7 illustrates an example, non-limiting top-down view of a superconductor ribbon cable structure with a double stripline structure comprising an up-down configuration in accordance with one or more embodiments described herein.

FIG. 8 illustrates an example, non-limiting top-down view of disconnecting a first stripline or a second stripline in a double stripline structure comprising an up-down configuration in accordance with one or more embodiments described herein.

FIGS. 9 and 10 illustrate example, non-limiting double stripline structures in accordance with one or more embodiments described herein.

FIG. 11 illustrates an example, non-limiting cross-sectional view of a disconnected stripline in a double stripline structure in accordance with one or more embodiments described herein.

FIGS. 12-21 illustrate simulated performance results based on fabricated superconductor ribbon cable structures with double stripline structures.

FIG. 22 illustrates a flow diagram of an example, non-limiting method in accordance with one or more embodiments described herein.

FIG. 23 illustrates a flow diagram of an example, non-limiting method in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

According to an embodiment, a superconductor ribbon cable structure is provided. The superconductor ribbon cable structure can comprise a top ground plane and a bottom ground plane. The superconductor ribbon cable structure can further comprise a core substrate between the top ground plane and the bottom ground plane. The superconductor ribbon cable structure can further comprise a double stripline structure in the core substrate, the double stripline structure comprising a first stripline and a second stripline, wherein the second stripline is a floating stripline. Such embodiment of the superconductor ribbon cable structure can provide a number of advantages, including improving superconductor flexible ribbon cable yields and extending fabricable length of superconductor flexible ribbon cables.

In one or more embodiments of the superconductor ribbon cable structure, the double stripline structure can comprise a side-by-side configuration, wherein the first stripline and the second stripline are in the core substrate. In one or more embodiments of the superconductor ribbon cable structure, the superconductor ribbon cable structure can further comprise an adhesive layer in the core substrate, wherein the first stripline and the second stripline are on the adhesive layer. In one or more embodiments of the superconductor ribbon cable structure, the superconductor ribbon cable structure can be a flex ribbon cable. In one or more embodiments of the superconductor ribbon cable structure, the double stripline structure can comprise a plurality of floating striplines. Such embodiments of the superconductor ribbon cable structure can provide a number of advantages, including decreasing probabilities of fabricating defected striplines and improving superconductor flexible ribbon cable yields.

According to an embodiment, a superconductor ribbon cable structure is provided. The superconductor ribbon cable structure can comprise a top ground plane and a bottom ground plane. The superconductor ribbon cable structure can further comprise a substrate between the top ground plane and the bottom ground plane. The superconductor ribbon cable structure can further comprise a double stripline structure in the substrate, the double stripline structure comprising a first stripline and a second stripline, wherein the second stripline is a floating stripline. The double stripline structure can further comprise a connecting tab on each end of the double stripline structure that connects the first stripline. Such embodiment of the superconductor ribbon cable structure can provide a number of advantages, including improving superconductor flexible ribbon cable yields and extending fabricable length of superconductor flexible ribbon cables.

In one or more embodiments of the superconductor ribbon cable structure, the substrate can comprise a top substrate and a bottom substrate. In one or more embodiments of the superconductor ribbon cable structure, the double stripline structure can comprise a side-by-side configuration, wherein the first stripline and the second stripline are on a bottom surface of the top substrate. In one or more embodiments of the superconductor ribbon cable structure, the connecting tab on each end of the double stripline structure can be in the top ground plane or in the bottom ground plane. In one or more embodiments of the superconductor ribbon cable structure, the superconductor ribbon cable structure can be a flex ribbon cable. In one or more embodiments of the superconductor ribbon cable structure, the superconductor ribbon cable structure can further comprise a plurality of vias that connect the substrate, the first stripline, the second stripline, or the connecting tab on each end of the double stripline structure. In one or more embodiments of the superconductor ribbon cable structure, the superconductor ribbon cable structure can further comprise an adhesive layer that attaches the top substrate and the bottom substrate. In one or more embodiments of the superconductor ribbon cable structure, the double stripline structure can comprise an up-down configuration, wherein the first stripline is on a bottom surface of the top substrate, and wherein the second stripline is on a top surface of the bottom substrate. In one or more embodiments of the superconductor ribbon cable structure, the connecting tab on each end of the double stripline structure can comprise a connecting tab in the top ground plane; and a connecting tab in the bottom ground plane. In one or more embodiments of the superconductor ribbon cable structure, the double stripline structure can comprise a plurality of floating striplines. Such embodiments of the superconductor ribbon cable structure can provide a number of advantages, including decreasing probabilities of fabricating defected striplines and improving superconductor flexible ribbon cable yields.

According to an embodiment, a method is provided. The method can comprise creating a double stripline structure in a substrate, the double stripline structure comprising a first stripline and a second stripline that are connected at each end of the double stripline structure. The method can further comprise depositing a bottom ground plane on a bottom surface of the substrate. The method can further comprise disconnecting the first stripline or the second stripline in response to a defect in the first stripline or the second stripline. The method can further comprise depositing a top ground plane on a top surface of the substrate.

In one or more embodiments of the method, disconnecting the first stripline or the second stripline can further comprise: removing a portion of each end of the first stripline; or removing a portion of each end of the second stripline. In one or more embodiments of the method, the method can further comprise attaching connecting tabs on the top ground plane or the bottom ground plane, wherein disconnecting the first stripline or the second stripline comprises: removing a portion of the connecting tab on each end of the double stripline structure. In one or more embodiments of the method, the method can further comprise disconnecting the first stripline or the second stripline by laser cutting, mechanical cutting, or electrical cutting. In one or more embodiments of the method, the double stripline structure can comprise a plurality of striplines that are connected at each end of the double stripline structure, the method further comprising disconnecting the plurality of striplines. Such embodiments of the superconductor ribbon cable structure can provide a number of advantages, including decreasing probabilities of fabricating defected striplines and improving superconductor flexible ribbon cable yields by removing defected or redundant striplines.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Superconductor ribbon cables, particularly superconductor flexible ribbon cables, are used in many electronic devices for high-performance striplines for high-speed signalling with minimal signal distortion and attenuation. More specifically, superconductor flexible ribbon cables provide efficient transmission of large amounts of electrical power with minimal energy loss by leveraging zero electrical resistance properties of superconducting materials. Superconductor flexible ribbon cables typically transmit radio frequency (RF) signals from one end of the superconductor flexible ribbon cable to the other through a plurality of channels. However, manufacturing processes for superconductor flexible ribbon cables are underdeveloped, resulting in lower yields of superconductor flexible ribbon cables, or lower proportions of fabricated superconductor flexible ribbon cables that meet functionality requirements. Particularly, superconductor flexible ribbon cables can suffer defects to the channels within the superconductor flexible ribbon cables. For instance, superconductor flexible ribbon cables with thick superconductor material (such as Niobium) designs exhibit improved insertion loss, however, they also have little to no yield of superconductor flexible ribbon cables. The low yield occurs because all channels must be functional (e.g., not defective), which is challenging to achieve (e.g., the superconductor flexible ribbon cable can not be used if one out of any number of channels is defective). Some existing techniques may provide channel failure tolerance. However, such existing techniques can still exhibit variable performance and low yields. As another example, some existing designs of superconductor flexible ribbon cables exhibit higher yields at direct current (DC) levels, however, exhibit varying and unreliable performance for RF signals. Existing methods supply no technique or architecture of the superconductor flexible ribbon cables that allow switching or removal of defective channels. In other words, existing methods do not provide a substitute channel for defective channels while avoiding redundancy of multiple channels. Thus, methods and structures that can address one or more of the challenges discussed herein while being easy to detect, use and implement in the industry, can be desirable.

To that end, various embodiments herein relate to a unique structure and method of forming a superconductor ribbon cable structure that can have a number of advantages. For example, the various embodiments herein can comprise a superconductor ribbon cable structure that can be fabricated to comprise a double stripline structure that comprises a first stripline and a second stripline, wherein the first stripline is connected to the second stripline at each end of the double stripline structure. The double stripline structure can comprise a bifurcated stripline structure or can comprise a stacked stripline structure. More specifically, the bifurcated stripline structure consists of the first stripline and the second stripline arranged on a same plane or signal level of the superconductor ribbon cable. The stacked stripline structure can consist of the first stripline and the second stripline arranged on different planes or signal levels of the superconductor ribbon cable (e.g., the first stripline is positioned above the second stripline on a different signal level).

The double stripline structure can be formed such that the first stripline or the second stripline can be disconnected from the double stripline structure in response to a defect in the first stripline or the second stripline, thereby increasing the probability of fabricating a channel that is not defective. Accordingly, by increasing the probability of fabricating a channel that is not defective, the yield of superconductor flexible ribbon cables increases. A stripline that has been disconnected at both ends (e.g., has been cut at each end, a portion has been removed from each end) within the double stripline structure can be considered a floating stripline. In other words, floating means that the stripline is isolated and not connected at either end of the double stripline structure. In this state, the floating stripline does not carry or provide a defined path for transmitting a signal from one end of the double stripline structure to the other end.

The various embodiments of the superconductor ribbon cable structure discussed herein can be applicable to electronic systems, such as high-performance computing devices, advanced communication systems, sensitive scientific instruments, medical imaging devices, energy-efficient power transmission, etc.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

It should also be understood that when an element such as a connecting tab, a double stripline structure, etc. is referred to as being “on” or “over” another element, it can be directly on the other element or intervening elements can also be present. In contrast, when an element is referred to as being “directly on” or “directly over” another element, there are no intervening elements present. It should also be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present.

These and other aspects and embodiments of the disclosed subject matter will now be described with respect to the drawings. It is to be appreciated that the words “superconductor ribbon cable”, “superconducting cable” and “superconductor flexible ribbon cable” have been used interchangeably throughout this specification.

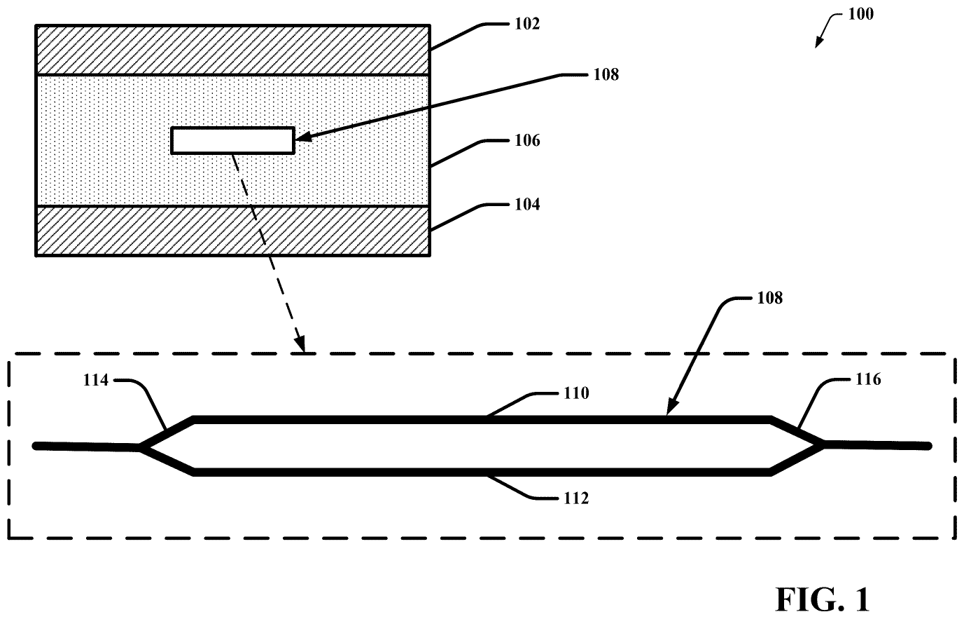

FIG. 1 illustrates an example, non-limiting cross-sectional view 100 of a superconductor ribbon cable structure with a double stripline structure in accordance with one or more embodiments described herein.

In an embodiment, a superconductor ribbon cable structure can comprise a top ground plane 102, a bottom ground plane 104, a substrate 106, and a double stripline structure 108. In various aspects, the substrate 106 can be above or on the bottom ground plane 104 and can further be below the top ground plane 102. In other words, the substrate 106 can be between the bottom ground plane 104 and the top ground plane 102. In various instances, the double stripline structure 108 can be in the substrate 106.

In various embodiments, the top ground plane 102 and the bottom ground plane 104 can be formed from any suitable material or elements, such as superconducting materials (e.g., Niobium, Niobium-Titanium, Lead) or conductive metals (e.g., Copper). In some embodiments, the substrate 106 can be any suitable dielectric material (e.g., polyimide, Liquid Crystal Polymer (LCP), Kapton, alumina, sapphire, fluoropolymers, copper-clad laminates, glass resin). In various embodiments, the double stripline structure 108 can be formed from any suitable material, such as superconducting materials (e.g., Niobium, Niobium-Titanium, Lead).

FIG. 1 further depicts a top-down view of the double stripline structure 108. In various, the double stripline structure 108 can comprise a first stripline 110 and a second stripline 112. The first stripline 110 and the second stripline 112 can be transmission line. A transmission line is any structures that can conduct electromagnetic waves in a contained manner (e.g., a pathway for electrical signals to travel from one point to another). In various aspects, as shown, the first stripline 110 and the second stripline 112 can be connected or joined at each end (e.g., end 114, end 116) of the double stripline structure 108. That is, the double stripline structure 108 can comprise a transmission line that branches in into two transmission lines (e.g., the first stripline 110 and the second stripline 112) at one end of the double stripline structure 108 and reconnects the two transmission lines into one transmission line (e.g., a terminal trace). For instance, as depicted in FIG. 1, the double stripline structure 108 comprises a transmission line that branches at end 114 into the first stripline 110 and the second stripline 112, and wherein the first stripline 110 and the second stripline 112 reconnect at end 116.

In various embodiments, the double stripline structure 108 can comprise a side-by-side configuration. That is, the first stripline 110 and on the second stripline 112 can be adjacent to each other and on a same layer of the superconductor ribbon cable structure. In other words, the double stripline structure 108 can be considered as a bifurcated stripline structure, wherein the first stripline 110 and the second stripline 112 are arranged on a same signal level in the superconductor ribbon cable.

It is to be appreciated that several layers and features of the superconductor ribbon cable structure illustrated in the cross-sectional and top-down views of FIG. 1 are also illustrated in cross-sectional and top-down views shown in other figures, although only some layers are discussed in detail for sake of brevity.

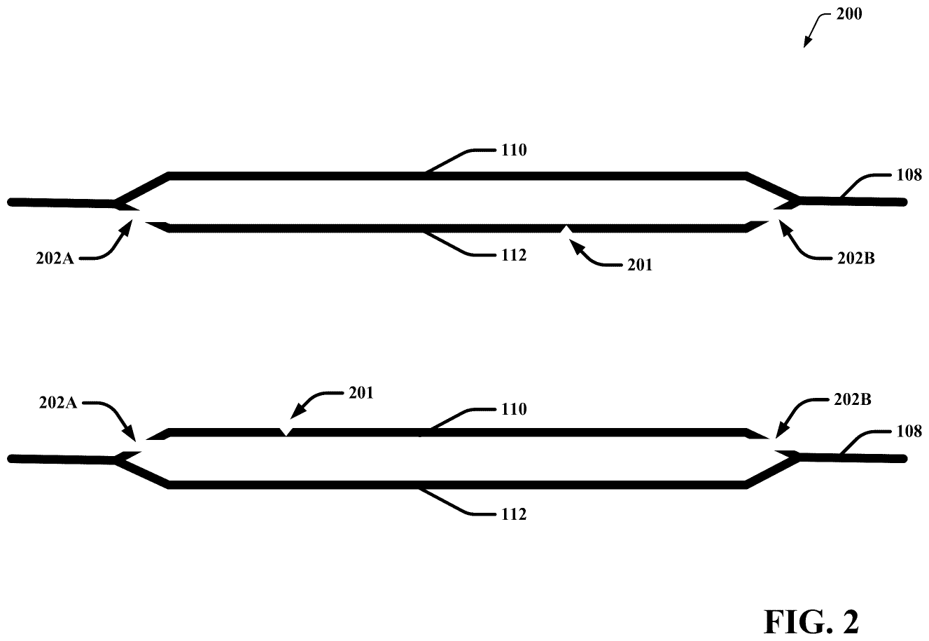

FIG. 2 illustrates example, non-limiting double stripline structures 200 and disconnecting a first stripline or a second stripline in accordance with one or more embodiments described herein.

In various instances, the first stripline 110 or the second stripline 112 can experience, comprise, or otherwise exhibit defects. For example, as shown in FIG. 2, the double stripline structure 108 can comprise a defect 201 on the second stripline 112. Accordingly, the second stripline 112 can be disconnected so that the first stripline 110 can functionally remain. In various aspects, the second stripline 112 can be disconnected by removing a portion of each end of the second stripline 112. The removed portion of the second stripline 112 can be, for example, a cut in the second stripline 112. For simplicity of explanation, removing a portion or the removed portion (of the first stripline 110 or the second stripline 112) are referred to herein as a cut. Accordingly, the second stripline 112 can be disconnected by a cut 202 at each end of the second stripline 112. Specifically, there can be a cut 202A on the second stripline 112 at end 114 and a cut 202B on the second stripline 112 at end 116.

As another example, as shown in FIG. 2, the double stripline structure 108 can comprise a defect 201 on the first stripline 110. Accordingly, the first stripline 110 can be disconnected so that the second stripline 112 can functionally remain. In various aspects, the first stripline 110 can be disconnected by a cut 202 at each end. Specifically, there can be a cut 202A on the first stripline 110 at end 114 and a cut 202B on the first stripline 110 at end 116.

Although not shown in FIG. 2, in cases where neither the first stripline 110 or the second stripline 112 contain any defects, either the first stripline 110 or the second stripline 112 can be selected to be disconnected to prevent interference or reflections from keeping both the first stripline 110 and the second stripline 112. In various instances, selection of which of the first stripline 110 or the second stripline 112 to disconnect can be based on the stripline removed from adjacent double stripline structures within the superconductor ribbon cable structure to further improve performance of the superconductor ribbon cable structure.

In various embodiments, any suitable method can be utilized to produce cut 202 (e.g., 202A and 202B). For example, the cut 202 can be made by laser cutting. Laser cutting can involve utilizing a high-powered laser beam to melt or vaporize material. As another example, the cut 202 can be made by mechanical cutting. Mechanical cutting can involve utilizing physical force to remove material (e.g., a blade, a saw, a drill). As still another example, cut 202 can be made by electrical cutting. Electrical cutting can involve passing a high current through the segment that is to be removed to melt or vaporize the material.

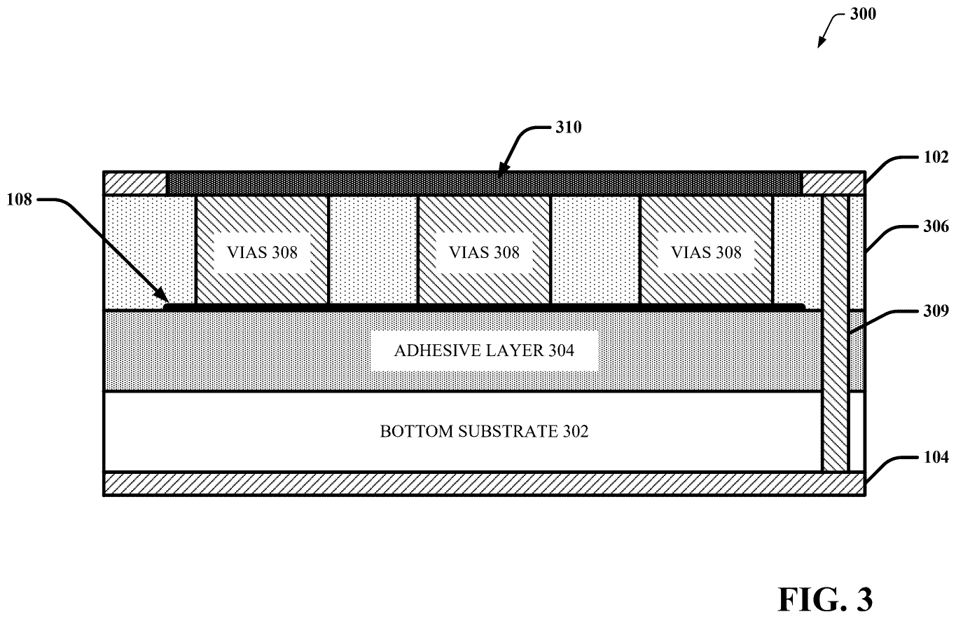

FIG. 3 illustrates an example, non-limiting cross-sectional view 300 of a superconductor ribbon cable structure with a double stripline structure in accordance with one or more embodiments described herein.

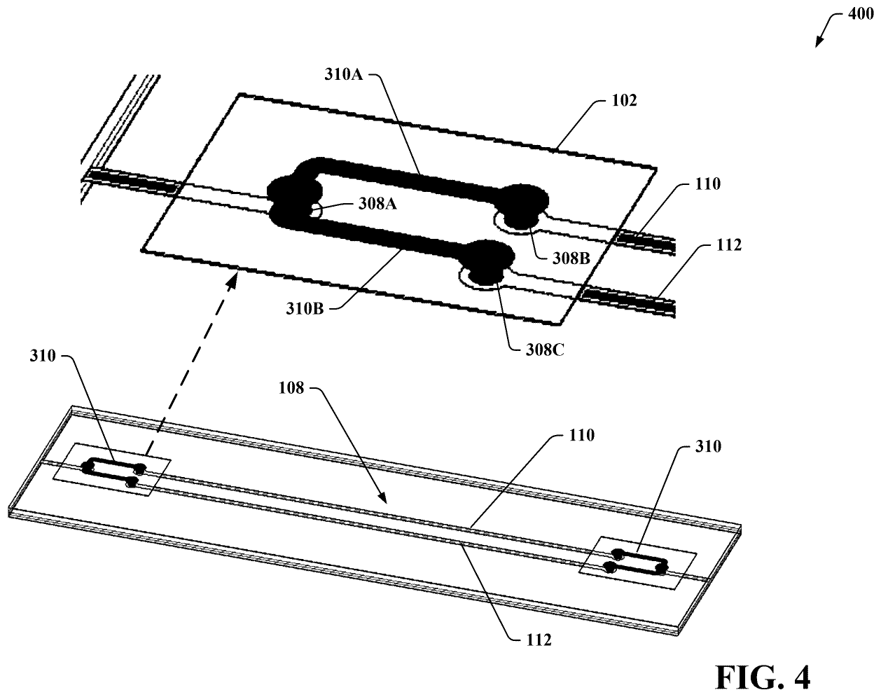

According to an embodiment, shown in FIG. 4, a superconductor ribbon cable structure can comprise the top ground plane 102, the bottom ground plane 104, and the double stripline structure 108, the double stripline structure 108 comprising the first stripline 110 and the second stripline 112. In various aspects, the superconductor ribbon cable structure can further comprise a core substrate 306, a bottom substrate 302, an adhesive layer 304, a connecting tab 310, and a plurality of vias 308.

In some embodiments, the double stripline structure 108 can be below or on the core substrate 306, and above the adhesive layer 304. In various embodiments, the bottom substrate 302 can be above or on the bottom ground plane 104. Further, the core substrate 306 can be below or on the top ground plane 102. In some instances, the core substrate 306 can be considered a top substrate. In various aspects, the adhesive layer 304 can be on the bottom substrate 302 and can attach the core substrate 306 to the bottom substrate 302. In various embodiments, the connecting tab 310 can be in the top ground plane 102. More specifically, the top ground plane 102 can comprise openings for the connecting tab 310 to enable the connecting tab 310 to connect the first stripline 110 and the second stripline 112. The connecting tab 310 can be placed on each end of the double stripline structure 108 (e.g., end 114 and end 116) to connect the first stripline 110 and the second stripline 112 at each end.

In various embodiments, the double stripline structure 108 can comprise a side-by-side configuration. That is, the first stripline 110 and on the second stripline 112 can be adjacent to each other and on a same layer of the superconductor ribbon cable structure. In other words, the double stripline structure 108 can be considered as a bifurcated stripline structure, wherein the first stripline 110 and the second stripline 112 are arranged on a same signal level in the superconductor ribbon cable.

In various aspects, the plurality of vias 308 can be in the core substrate 306. The plurality of vias 308 can create electrical connections between different layers of the superconductor ribbon cable structure (e.g., between connecting tab 310 in the top ground plane 102 and the double stripline structure 108 on the adhesive layer 304). The plurality of vias 308 can comprise a via at each end of the first stripline 110 and the second stripline 112, as well as at end 114 (or end 116) where the first stripline 110 and the second stripline 112 connect to form one transmission line. In various aspects, the superconductor ribbon cable structure can further comprise vias 309. The vias 309 can directly connect the top ground plane 102 to the bottom ground plane 104 without contacting the double stripline structure 108 (e.g., without contacting the signal plane).

According to some embodiments, alternatively, the double stripline structure 108 can instead be on the bottom substrate 302, and wherein the connecting tab 310 is in the bottom ground plane 104. Accordingly, the plurality of vias 308 can be in the bottom substrate 302 to create electrical connections between connecting tab 310 in the bottom ground plane 104 and the double stripline structure 108 on the bottom substrate 302. Such implementations are symmetrical, and can be implemented similarly in the bottom substrate 302 or the core substrate 306.

In some embodiments, the core substrate 306 and the bottom substrate 302 can be formed from any suitable material or elements, such as any suitable dielectric or laminate materials (e.g., polyimide, Kapton, alumina, sapphire, fluoropolymers, copper-clad laminates, glass resin).

FIG. 4 illustrates an example, non-limiting top-down view 400 of a superconductor ribbon cable structure with a double stripline structure in accordance with one or more embodiments described herein.

As shown in the top-down view 400, at each end of the double stripline structure 108, the first stripline 110 and the second stripline 112 can be connected by the connecting tab 310. Specifically, the top ground plane 102 can comprise openings at each end of the first stripline 110 and the second stripline 112, as well as where the first stripline 110 and the second stripline 112 connect to form one transmission line. At these openings, there can be the plurality of vias 308. Therefore, there can be a via 308B at the end of first stripline 110, a via 308C at the end of second stripline 112, and a via 308A where the first stripline 110 and the second stripline 112 connect to form one transmission line. In various aspects, the connecting tab 310 can comprise a connecting tab 310A and a connecting tab 310B that meet at via 308A. From the via 308A to the via 308B, the connecting tab 310A in the top ground plane 102 (or bottom ground plane 104) can connect the first stripline 110. In various aspects, from the via 308A to the via 308C, the connecting tab 310B in the top ground plane 102 (or bottom ground plane 104) can connect the second stripline 112.

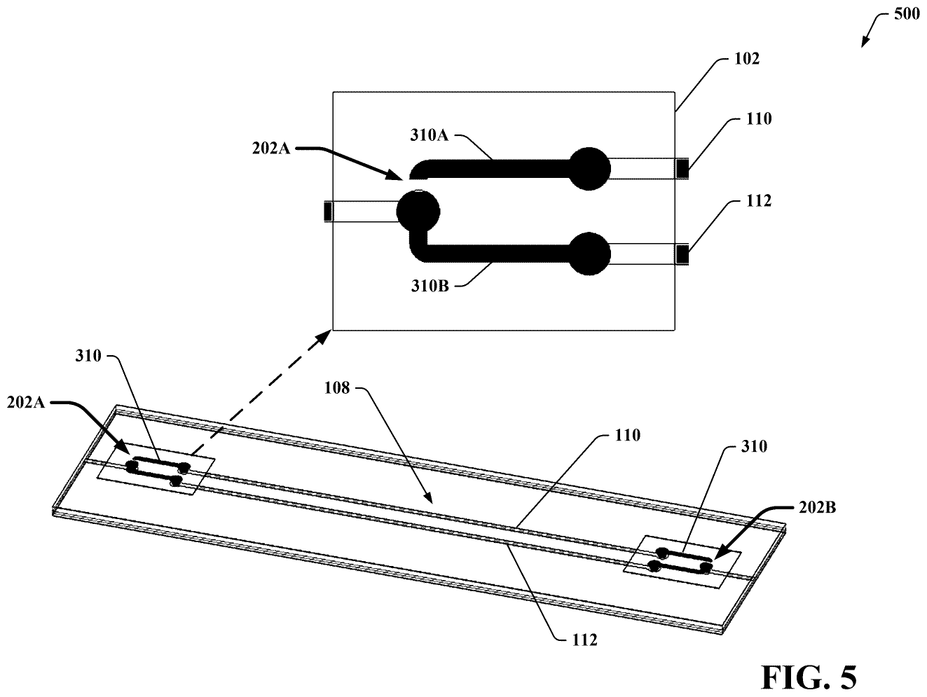

FIG. 5 illustrates an example, non-limiting top-down view 500 of disconnecting a first stripline or a second stripline in a double stripline structure in accordance with one or more embodiments described herein.

As described previously with respect to FIG. 2, the first stripline 110 or the second stripline 112 can be disconnected in response to a defect in the first stripline 110 or the second stripline 112. For example, there can be a defect in the first stripline 110. Accordingly, as shown in the top-down view 500, the first stripline 110 can be disconnected by cutting the connecting tab 310. In particular, the first stripline 110 can be disconnected by cutting the connecting tab 310A that connects the first stripline 110. In various aspects, the connecting tab 310 can be cut using laser cutting, mechanical cutting, or electrical cutting. In various aspects, the location of the cut on the connecting tab 310 can be close or near a corresponding via of the plurality of vias 308. For instance, if disconnecting the first stripline 110, the location of the cut on the connecting tab 310A should be close to the location of via 308B. Similarly, if disconnecting the second stripline 112, the location of the cut on the connecting tab 310B should be close to the location of via 308C.

The connecting tab 310 can be cut on each end of the double stripline structure 108, resulting in cut 202A at end 114 and cut 202B at end 116 of the double stripline structure 108.

Although not shown in FIGS. 4 and 5, the superconductor ribbon cable structure can further comprise the vias 309 that directly connect the top ground plane 102 to the bottom ground plane 104 without contacting the double stripline structure 108.

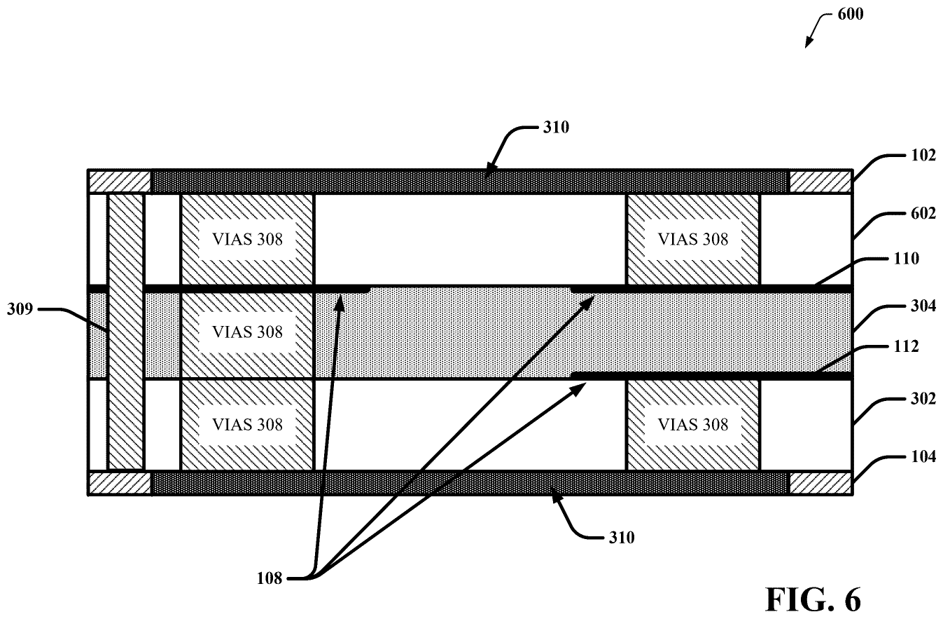

FIG. 6 illustrates an example, non-limiting cross-sectional view 600 of a superconductor ribbon cable structure with a double stripline structure comprising an up-down configuration in accordance with one or more embodiments described herein.

According to an embodiment, a superconductor ribbon cable structure can comprise the top ground plane 102, the bottom ground plane 104, the bottom substrate 302, the adhesive layer 304, the connecting tab 310, the plurality of vias 308, and the double stripline structure 108, the double stripline structure 108 comprising the first stripline 110 and the second stripline 112. In various aspects, the superconductor ribbon cable structure can further comprise a top substrate 602.

In various embodiments, the double stripline structure 108 can comprise an up-down configuration (e.g., broadside coupling). That is, the first stripline 110 can be above the second stripline 112 in the superconductor ribbon cable structure. Specifically, the first stripline 110 can be on a bottom surface of the top substrate 602 and the second stripline 112 can be on a top surface of the bottom substrate 302. In other words, the double stripline structure 108 can be considered as a stacked stripline structure, wherein the first stripline 110 and the second stripline 112 are arranged on different signal levels in the superconductor ribbon cable. Furthermore, in some cases, it can be desirable to not place the first stripline 110 and the second stripline 112 directly on top of each other. That is, the first stripline 110 can be placed offset from the second stripline 112.

In some embodiments, the top substrate 602 can be below or on the top ground plane 102. In various aspects, the adhesive layer 304 can be on the bottom substrate 302 and can attach the top substrate 602 to the bottom substrate 302. In various embodiments, the connecting tab 310 can be in the top ground plane 102 and the bottom ground plane 104. Further, the top ground plane 102 and the bottom ground plane 104 can comprise openings for the connecting tab 310. Thus, via the openings, the connecting tab 310 can connect the first stripline 110 and the second stripline 112. The connecting tab 310 can be placed on each end of the double stripline structure 108 (e.g., end 114 and end 116) and in both ground planes (e.g., top ground plane 102 and bottom ground plane 104) to connect the first stripline 110 and the second stripline 112 at each end.

In various aspects, the plurality of vias 308 can be in the top substrate 602, the bottom substrate 302, and the adhesive layer 304 to create electrical connections between different layers of the superconductor ribbon cable structure (e.g., between connecting tab 310 in the top ground plane 102, connecting tab 310 in the bottom ground plane 104, the double stripline structure 108, and the adhesive layer 304). The plurality of vias 308 can comprise a via at each end of the first stripline 110 and the second stripline 112, as well as at end 114 (or end 116) where the first stripline 110 and the second stripline 112 connect to form one transmission line.

In various aspects, the superconductor ribbon cable structure can further comprise vias 309. The vias 309 can directly connect the top ground plane 102 to the bottom ground plane 104 without contacting the double stripline structure 108.

In some embodiments, the top substrate 602 can be formed any suitable material or elements, such as any suitable dielectric or laminate materials (e.g., polyimide, Kapton, alumina, sapphire, fluoropolymers, copper-clad laminates, glass resin).

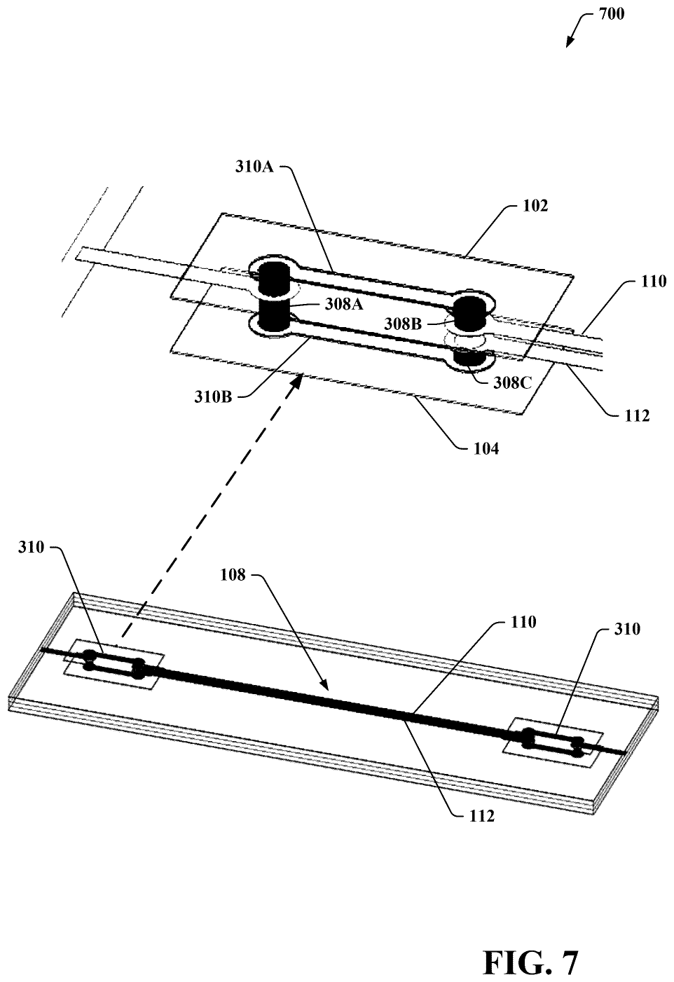

FIG. 7 illustrates an example, non-limiting top-down view 700 of a superconductor ribbon cable structure with a double stripline structure comprising an up-down configuration in accordance with one or more embodiments described herein.

As shown in the top-down view 400, at each end of the double stripline structure 108, the first stripline 110 and the second stripline 112 can be connected by the connecting tab 310. Specifically, the top ground plane 102 can comprise openings at each end of the first stripline 110 and where the first stripline 110 and the second stripline 112 connect to form one transmission line. Further, the bottom ground plane 104 can comprise openings at each end of the second stripline 112 and where the first stripline 110 and the second stripline 112 connect to form one transmission line. At these openings, there can be the plurality of vias 308. Therefore, there can be the via 308B at the end of first stripline 110, the via 308C at the end of second stripline 112, and the via 308A where the first stripline 110 and the second stripline 112 connect to form one transmission line. In various aspects, the connecting tab 310 can comprise a connecting tab 310A and a connecting tab 310B that meet at via 308A. From the via 308A to the via 308B, the connecting tab 310A in the top ground plane 102 can connect the first stripline 110. In various aspects, from the via 308A to the via 308C, the connecting tab 310B in the bottom ground plane 104 can connect the second stripline 112.

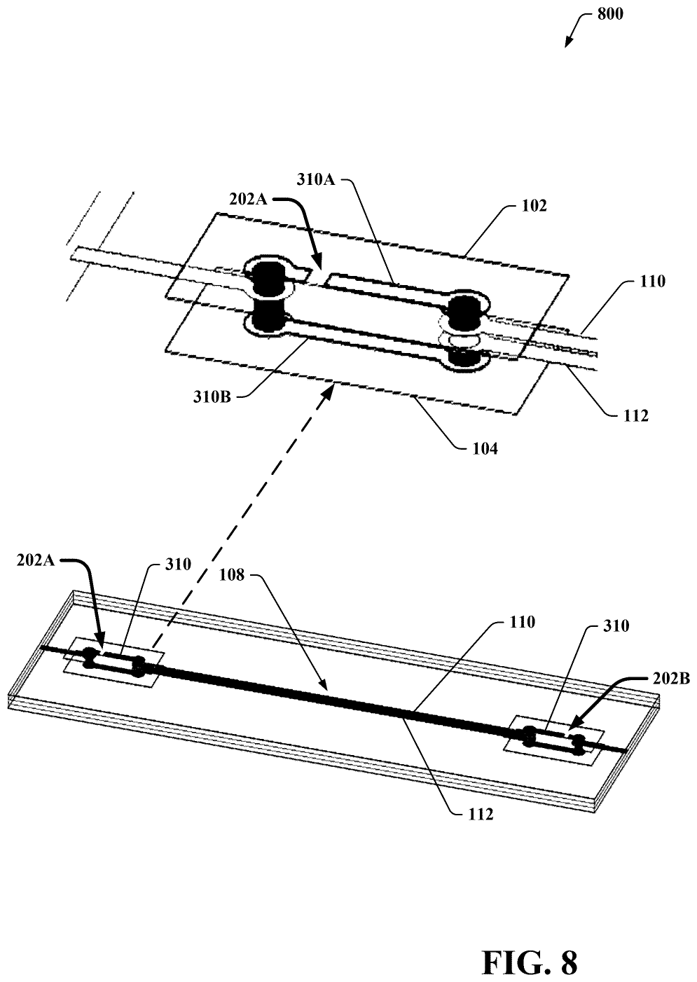

FIG. 8 illustrates an example, non-limiting top-down view 800 of disconnecting a first stripline or a second stripline in a double stripline structure comprising an up-down configuration in accordance with one or more embodiments described herein.

As described previously with respect to FIG. 2, the first stripline 110 or the second stripline 112 can be disconnected in response to a defect in the first stripline 110 or the second stripline 112. For example, there can be a defect in the first stripline 110. Accordingly, as shown in the top-down view 800, the first stripline 110 can be disconnected by cutting the connecting tab 310. In particular, the first stripline 110 can be disconnected by cutting the connecting tab 310A in the top ground plane 102 that connects the first stripline 110. In various aspects, the connecting tab 310 can be cut using laser cutting, mechanical cutting, or electrical cutting.

The connecting tab 310 can be cut on each end of the double stripline structure 108, resulting in cut 202A at end 114 and cut 202B at end 116 of the double stripline structure 108.

Although not shown in FIGS. 7 and 8, the superconductor ribbon cable structure can further comprise the vias 309 that directly connect the top ground plane 102 to the bottom ground plane 104 without contacting the double stripline structure 108.

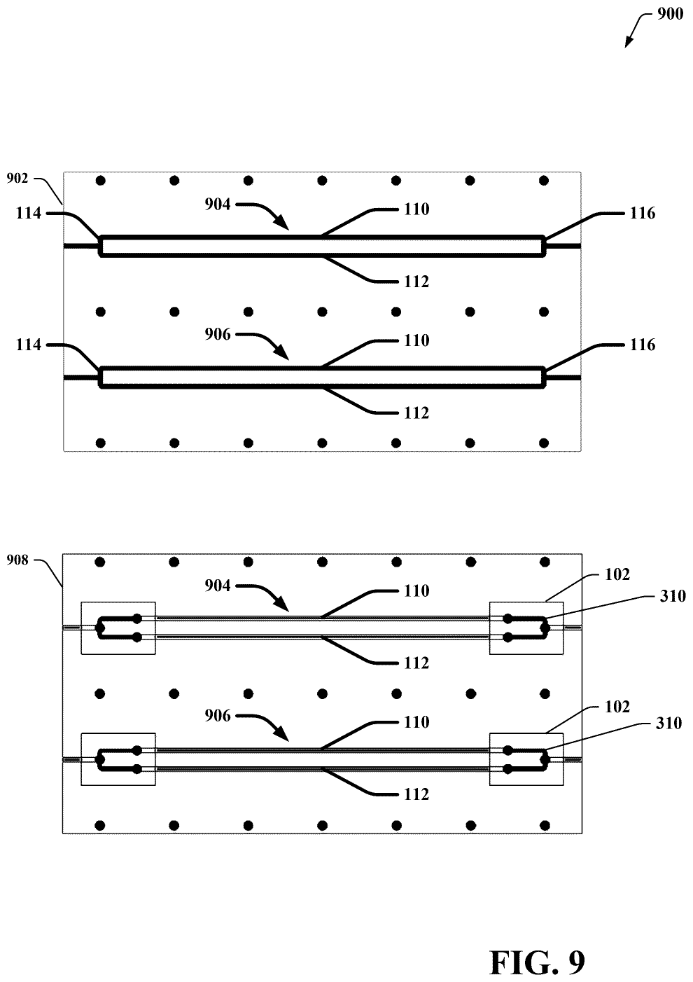

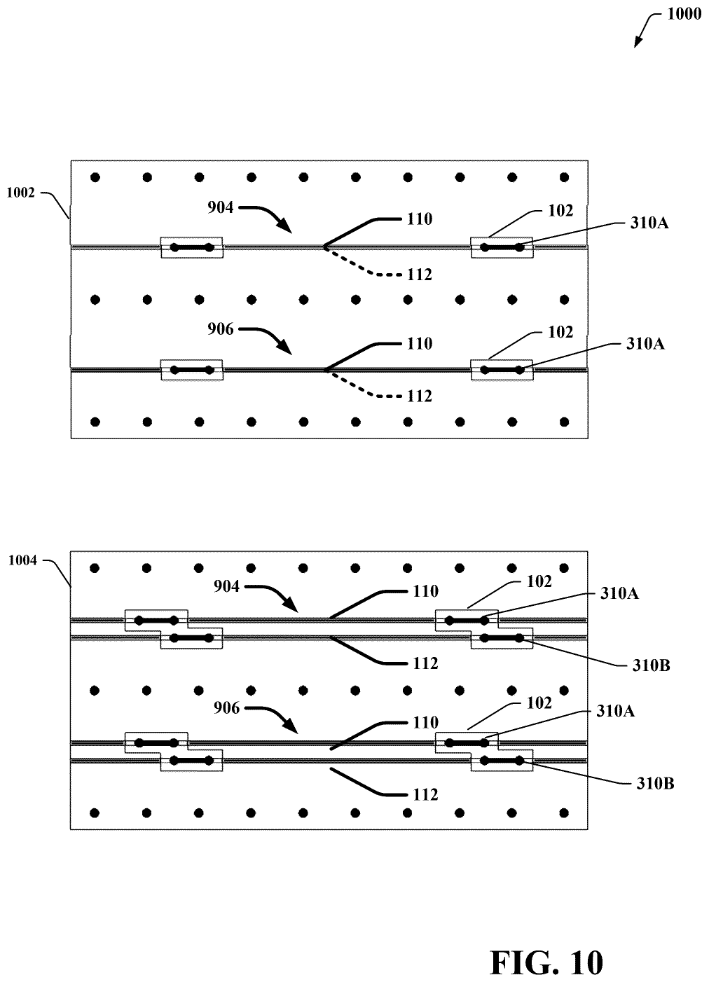

FIGS. 9 and 10 illustrates example, non-limiting double stripline structures in accordance with one or more embodiments described herein.

As shown in FIG. 9, there can be other implementation arrangements of the first stripline 110 and the second stripline 112 in superconductor flexible ribbon cables. Furthermore, a superconductor ribbon cable structure can comprise one or more of the double stripline structure 108. For example, implementation 902 depicts a first double stripline structure 904 and a second double stripline structure 906, wherein the first double stripline structure 904 and a second double stripline structure 906 can be described with respect to FIG. 1. That is, the first double stripline structure 904 and a second double stripline structure 906 can each comprise first stripline 110 and second stripline 112 that are connected at each end of the double stripline structure 904 and the double stripline structure 906.

As another example, implementation 908 depicts the first double stripline structure 904 and the second double stripline structure 906, wherein the first double stripline structure 904 and a second double stripline structure 906 can be described with respect to FIGS. 3-5. That is, the first double stripline structure 904 and a second double stripline structure 906 can each comprise first stripline 110 and second stripline 112 that are connected at each end of the double stripline structure 904 and the double stripline structure 906 by connecting tab 310 in the top ground plane 102. In some cases, the connecting tab 310 can be in the bottom ground plane 104.

As shown in FIG. 10, as yet another example, implementation 1002 depicts the first double stripline structure 904 and the second double stripline structure 906, wherein the first double stripline structure 904 and a second double stripline structure 906 can be described with respect to FIGS. 6-8. That is, the first double stripline structure 904 and a second double stripline structure 906 can each comprise first stripline 110 and second stripline 112 that are connected at each end of the double stripline structure 904 and the double stripline structure 906 by connecting tab 310 in the top ground plane 102, wherein the double stripline structure 904 and the double stripline structure 906 comprise up-down configurations. As depicted in the top-down view of implementation 1002, the connecting tab 310A in the top ground plane 102 can connect the first stripline 110 to the connecting tab 310B and second stripline 112 beneath.

As still another example, implementation 1004 depicts the first double stripline structure 904 and the second double stripline structure 906. In various aspects, instead of connecting the first stripline 110 to the second stripline 112 with the connecting tab 310, the first stripline 110 to the second stripline 112 can remain separated. More specifically, the first stripline 110 can comprise three segments, wherein the middle segment, at each end of the double stripline structure 904 or the double stripline structure 906, can connect to the end segments via the connecting tab 310A. Similarly, the second stripline 112 can comprise three segments, wherein the middle segment, at each end of the double stripline structure 904 or the double stripline structure 906, can connect to the end segments via the connecting tab 310B. Therefore, in response to identifying a defect in first stripline 110, the connecting tab 310A can be cut, thereby disconnecting the first stripline 110. Also similarly, in response to identifying a defect in second stripline 112, the connecting tab 310B can be cut, thereby disconnecting the second stripline 112.

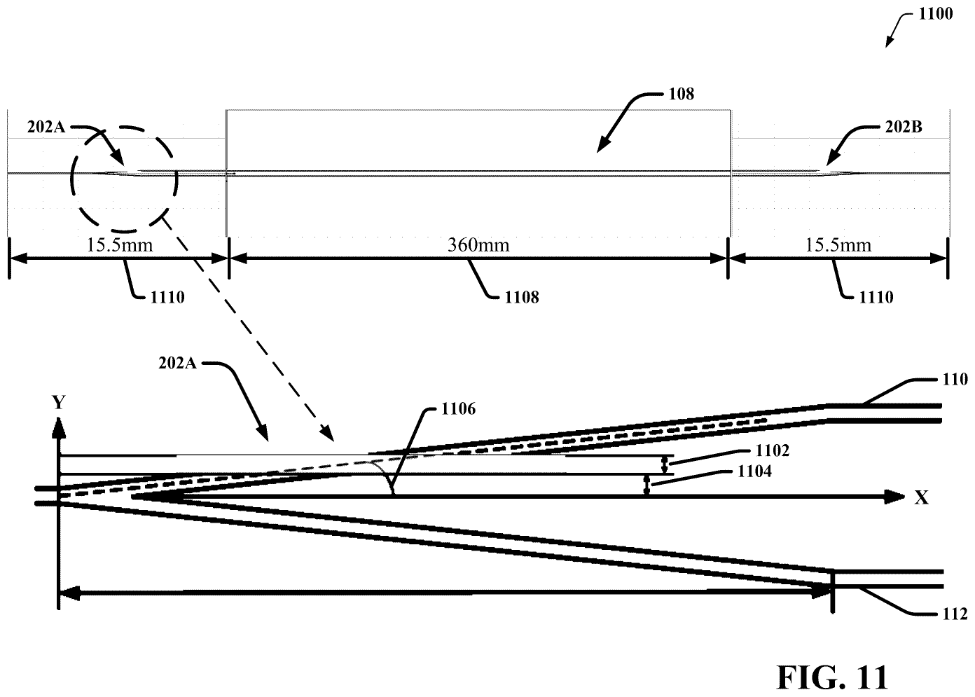

FIG. 11 illustrates an example, non-limiting cross-sectional view 1100 of a disconnected stripline in a double stripline structure in accordance with one or more embodiments described herein.

Depicted in FIG. 11 is an example implementation and fabrication design of double stripline structures. In particular, the double stripline structure 108 can, as a non-limiting example, comprise a total length (sum of distance 1110, distance 1108, and distance 1110) of 391 millimeters (mm). Further, the double stripline structure 108 can have the first stripline 110 be disconnected. In various aspects, the segment of the double stripline structure 108 where the transmission line branches into the first stripline 110 and the second stripline 112 can comprise a length 1110 of 15.5 mm on each end of the double stripline structure 108. The middle segment can comprise a length of 360 mm.

Further depicted in FIG. 11 is a cross-sectional view of the cut 202A (or 202B) of the first stripline 110 or the second stripline 112. In various embodiments, an angle 1106 of the first stripline 110 or the second stripline 112 from a x-axis can be between 3 to 14 degrees, however, any suitable angle of the first stripline 110 or the second stripline 112 can be implemented. As a non-limiting example, a width 1102 of the cut 202 (e.g., cut 202A or cut 202B) can be 100 um, and a distance 1104 from the x-axis to the start of the cut 202 can be 100 um. Note that, these are non-limiting examples, and that any suitable distances or angles described in FIG. 11 can be implemented. For example, the first stripline 110 and the second stripline 112 can be separated by larger distances, thereby mitigating residual coupling between the first stripline 110 and the second stripline 112.

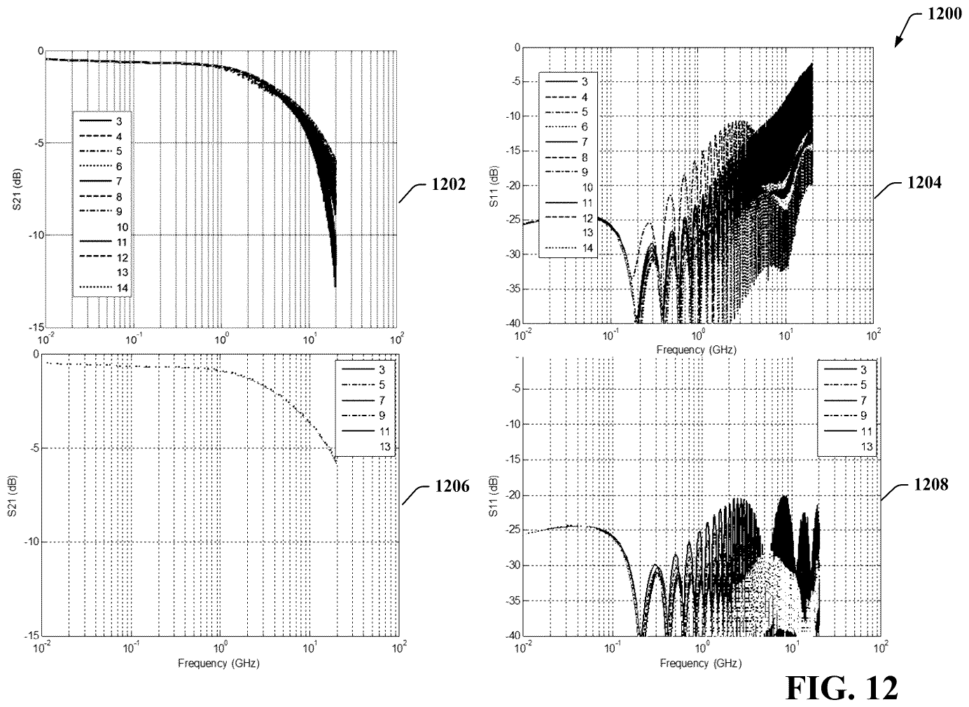

FIGS. 12-21 illustrate simulated performance results 1200-2100 based on fabricated superconductor ribbon cable structures with double stripline structures.

Turning to FIG. 12, in graph 1202, insertion loss and the amount of a signal that completely traverses the transmission line is measured against different measurements of angle 1106. As shown, between 3 to 14 degrees, the insertion loss at higher frequencies decreases as the angle 1106 increases.

In graph 1204, the amount of a signal that is reflected back to a source of the transmission line is measured against different measurements of angle 1106. As shown, between 3 to 14 degrees, the amount of a signal that is reflected at higher frequencies decreases as the angle 1106 increases.

Furthermore, the length of the remaining segment after cutting the first stripline 110 or the second stripline 112 at the connection point can affect insertion loss and the amount of a signal that is reflected. In particular, as shown in graph 1206 and graph 1208, at a decreased and fixed length, the insertion loss and the amount of signal that is reflected is decreased irrespective of the angle 1106. Thus, various embodiments described herein can decrease signal reflection and insertion loss at higher frequencies of the signal.

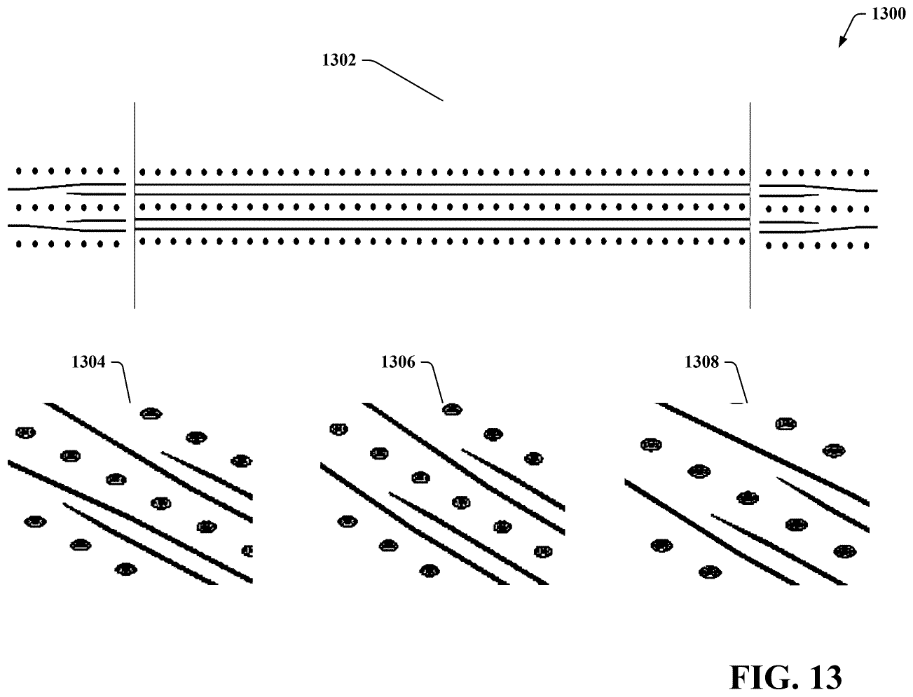

Turning to FIG. 13, an implementation can comprise two adjacent double stripline structures 1302 comprising a similar structure as described with respect to FIGS. 1 and 2. From the two adjacent double stripline structures 1302, there can be multiple configurations for disconnecting striplines from each double stripline structure. In configuration 1304, the first stripline 110 of the top double stripline structure and the second stripline 112 of the bottom double stripline structure are disconnected. In other words, the outside striplines between the two adjacent double stripline structures 1302 are disconnected.

In configuration 1306, the first stripline 110 of the top double stripline structure and the first stripline 110 of the bottom double stripline structure are disconnected. In other words, alternating striplines between the two adjacent double stripline structures 1302 are disconnected. This can also apply to disconnecting the second stripline 112 of the top double stripline structure and the second stripline 112 of the bottom double stripline structure.

In configuration 1308, the second stripline 112 of the top double stripline structure and the first stripline 110 of the bottom double stripline structure are disconnected. In other words, the inside striplines between the two adjacent double stripline structures 1302 are disconnected.

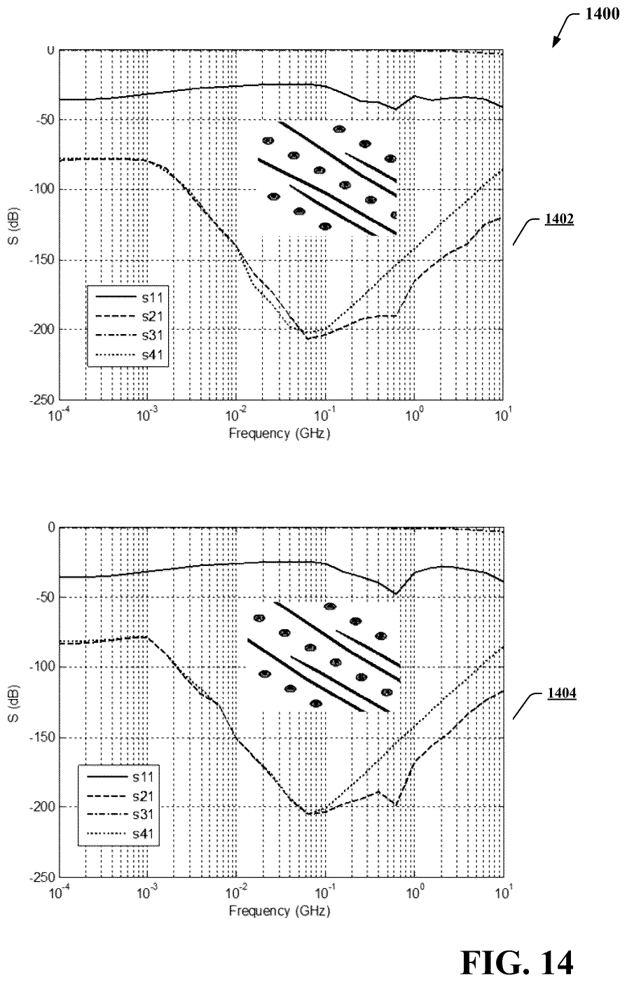

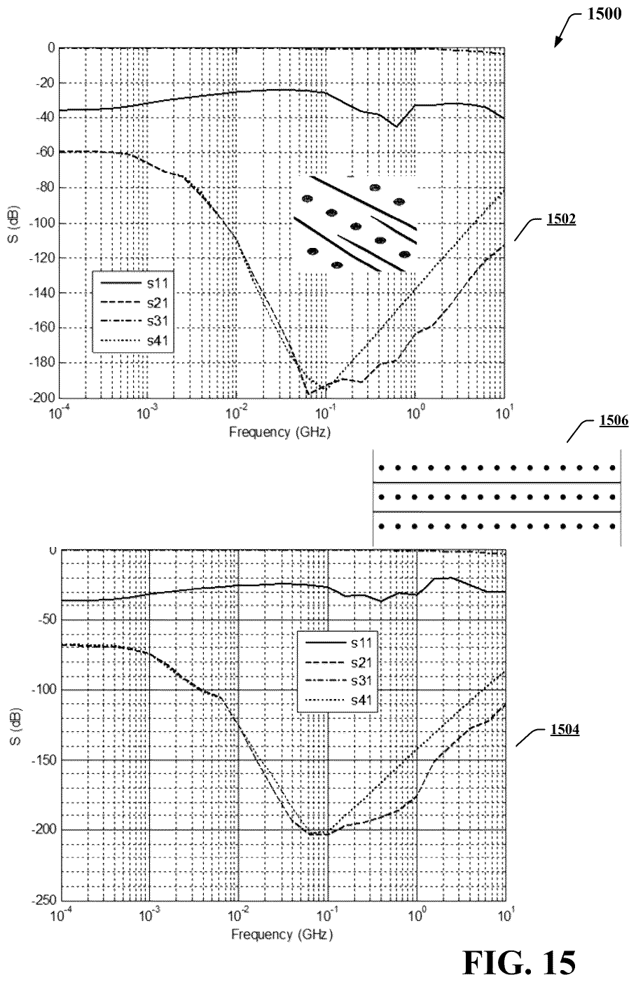

Turning to FIGS. 14 and 15, as shown in graph 1402, graph 1404, graph 1502, and graph 1504, crosstalk terms exhibit a decrease in configuration 1302 and configuration 1304 than implementing only single line transmission lines 1506 as in graph 1504.

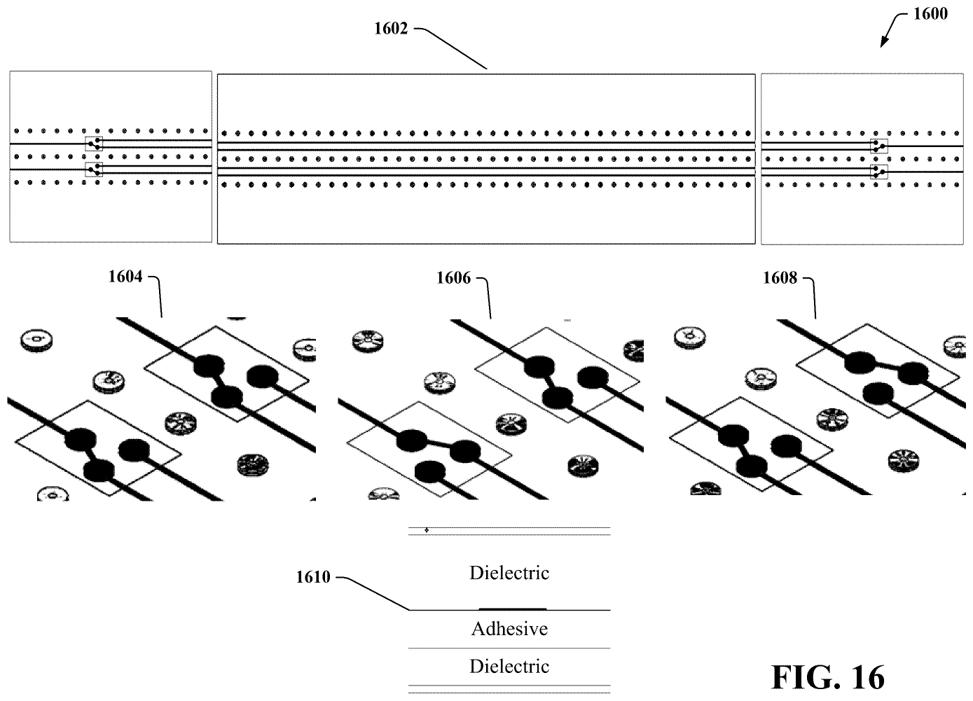

Turning to FIG. 16, an implementation can comprise two adjacent double stripline structures 1602 with fabrication design 1610 and comprising a similar structure as described with respect to FIGS. 3-5. From the two adjacent double stripline structures 1602, there can be multiple configurations for disconnecting striplines from each double stripline structure. In configuration 1604, the first stripline 110 of the top double stripline structure and the first stripline 110 of the bottom double stripline structure are disconnected by cutting the connecting tab 310. In other words, alternating connecting tabs are cut. This can also apply to disconnecting the second stripline 112 of the top double stripline structure and the second stripline 112 of the bottom double stripline structure.

In configuration 1606, the first stripline 110 of the top double stripline structure and the second stripline 112 of the bottom double stripline structure are disconnected. In other words, the outside connecting tabs are cut.

In configuration 1608, the second stripline 112 of the top double stripline structure and the first stripline 110 of the bottom double stripline structure are disconnected. In other words, the inside connecting tabs are cut.

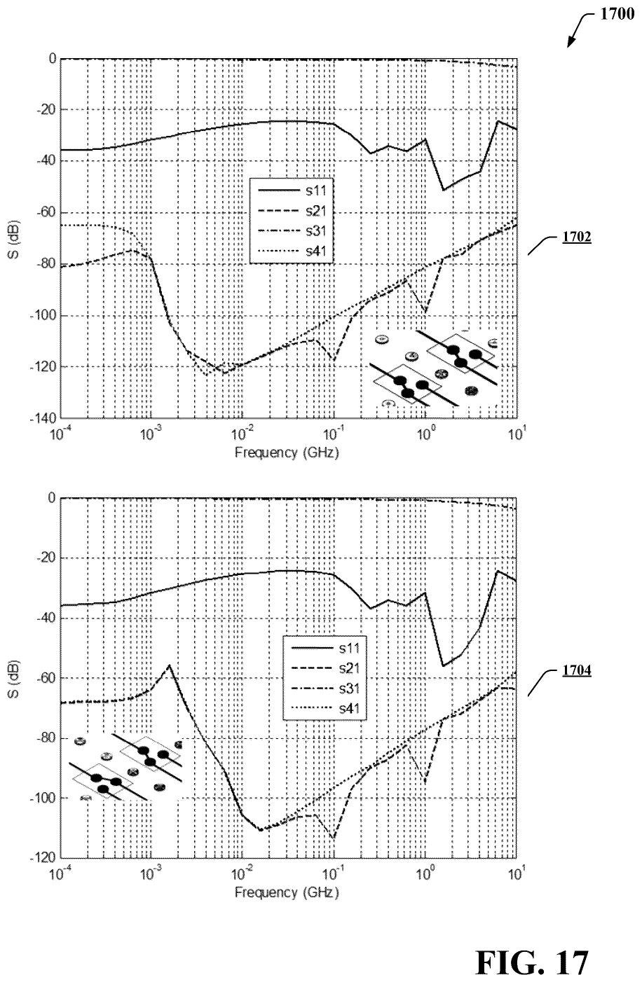

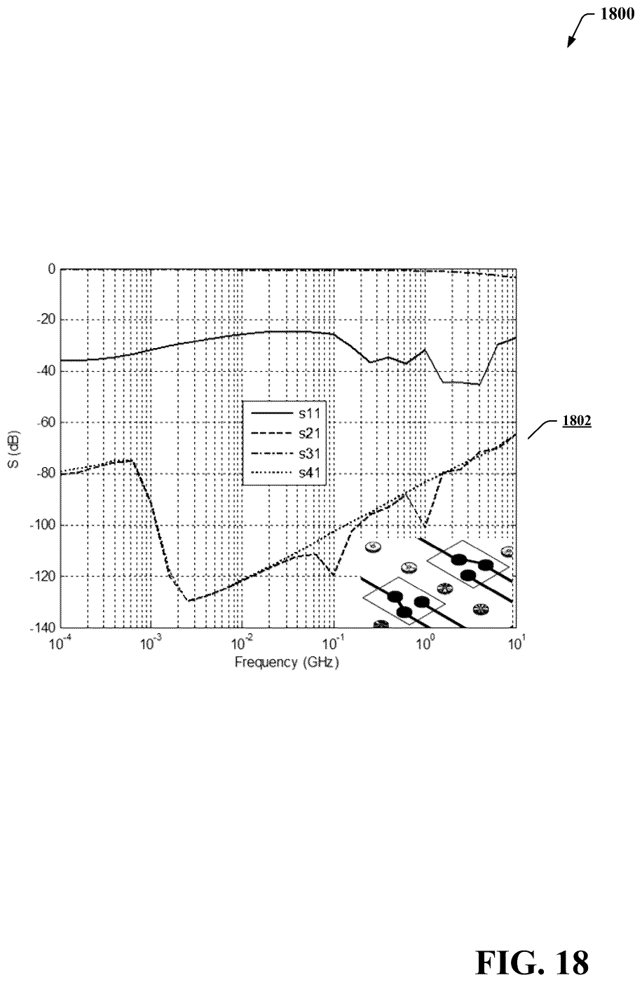

Turning to FIGS. 17 and 18, as shown in graph 1702, graph 1704, and graph 1802, crosstalk terms exhibit a decrease in configuration 1604 and configuration 1608 than configuration 1606.

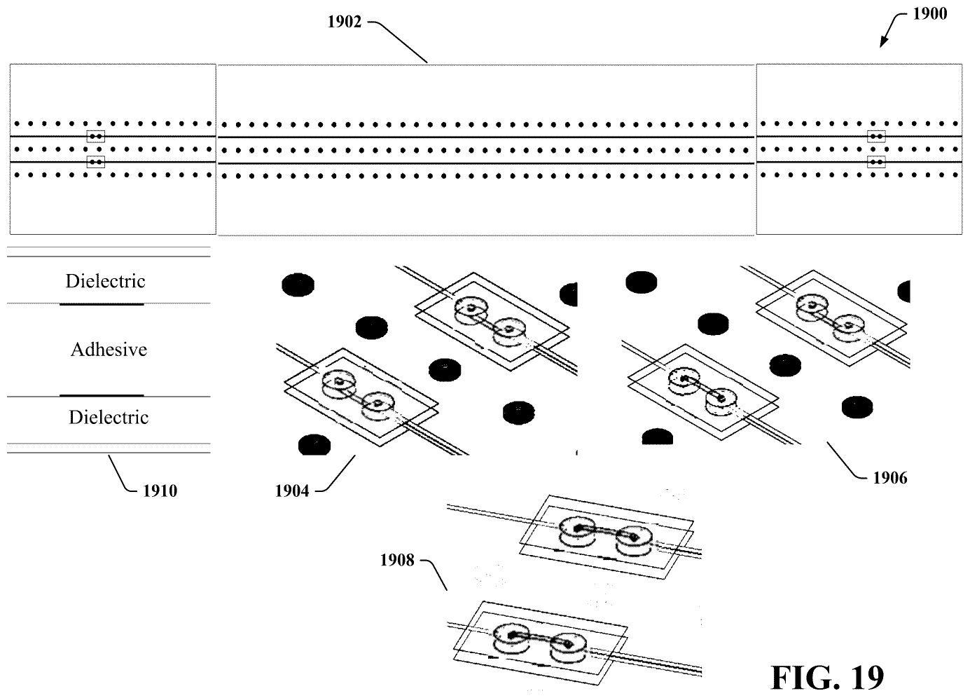

Turning to FIG. 19, an implementation can comprise two adjacent double stripline structures 1902 with fabrication design 1910 and comprising a similar structure as described with respect to FIGS. 6-8. From the two adjacent double stripline structures 1902, there can be multiple configurations for disconnecting striplines from each double stripline structure. In configuration 1904, the first stripline 110 of the top double stripline structure and the first stripline 110 of the bottom double stripline structure are disconnected by cutting the connecting tab 310. In other words, the connecting tab 310A of the two adjacent double stripline structures 1902 are cut.

In configuration 1906, the first stripline 110 of the top double stripline structure and the second stripline 112 of the bottom double stripline structure are disconnected. In other words, the connecting tab 310B of the top double stripline structure and the connecting tab 310A of the bottom double stripline structure are cut. This can also apply to disconnecting the second stripline 112 of the top double stripline structure and the first stripline 110 of the bottom double stripline structure.

In configuration 1908, the second stripline 112 of the top double stripline structure and the second stripline 112 of the bottom double stripline structure are disconnected by cutting the connecting tab 310. In other words, the connecting tab 310B of the two adjacent double stripline structures 1902 are cut.

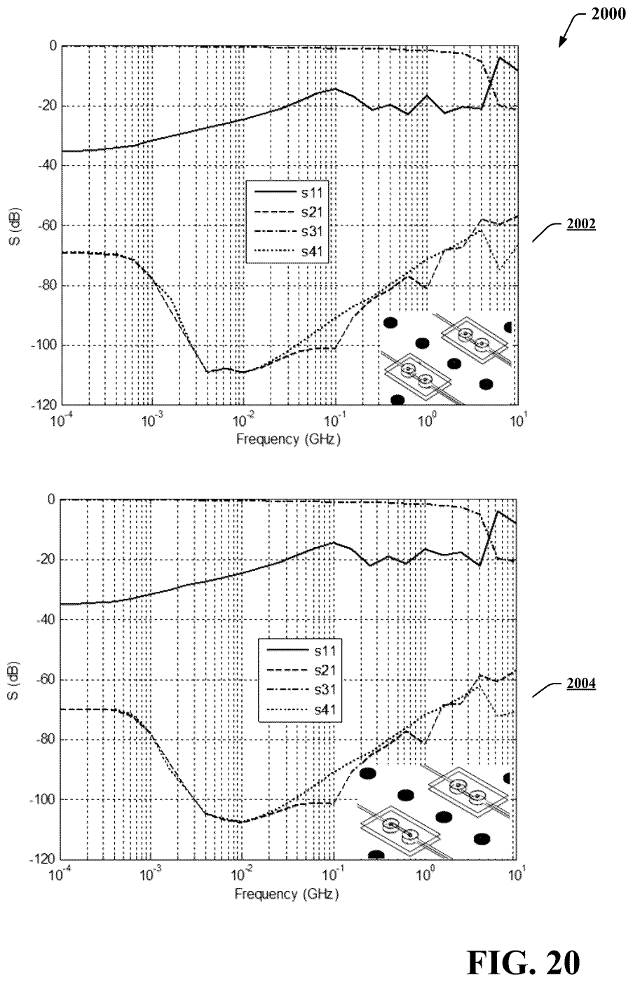

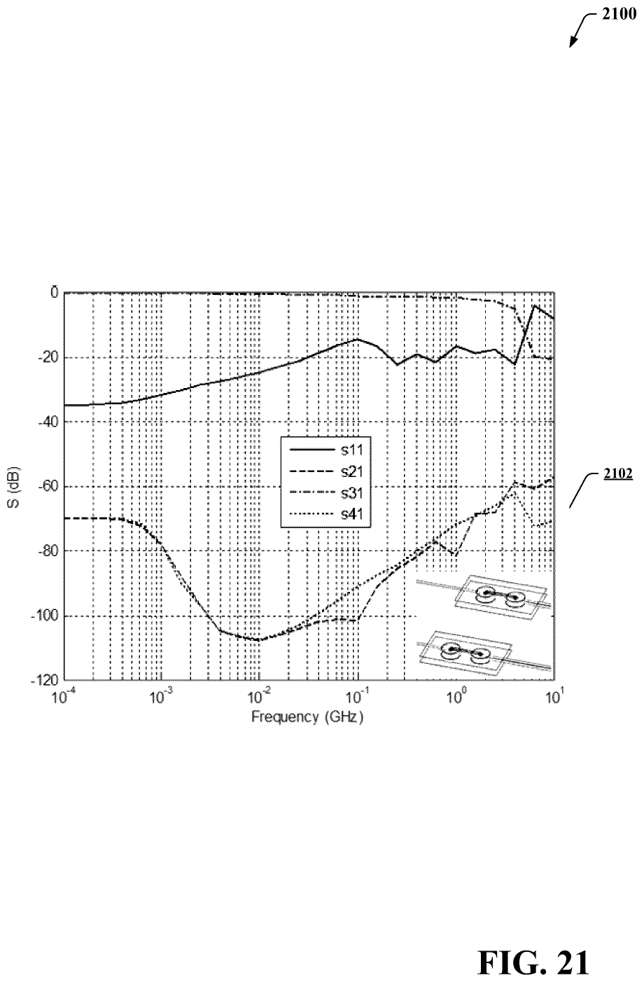

Turning to FIGS. 20 and 21, as shown in graph 2002, graph 2004, and graph 2102, crosstalk terms exhibit similar results in configuration 1904, configuration 1906, and configuration 1908. Thus, which of the connecting tab 310 are cut is not critical and has minimal affects on crosstalk.

In any case described in FIGS. 13-21, the simulated performance results can be utilized to determine which of the first stripline 110 or the second stripline 112 to disconnect in cases where neither stripline contains defects. Accordingly, performance of the superconductor ribbon cable can be optimized while removing defected striplines to improve yields of the semiconductor cables. In particular, performance of the superconductor ribbon cable can be optimized for higher frequencies by selecting which stripline to remove based on the configurations and their respective performances.

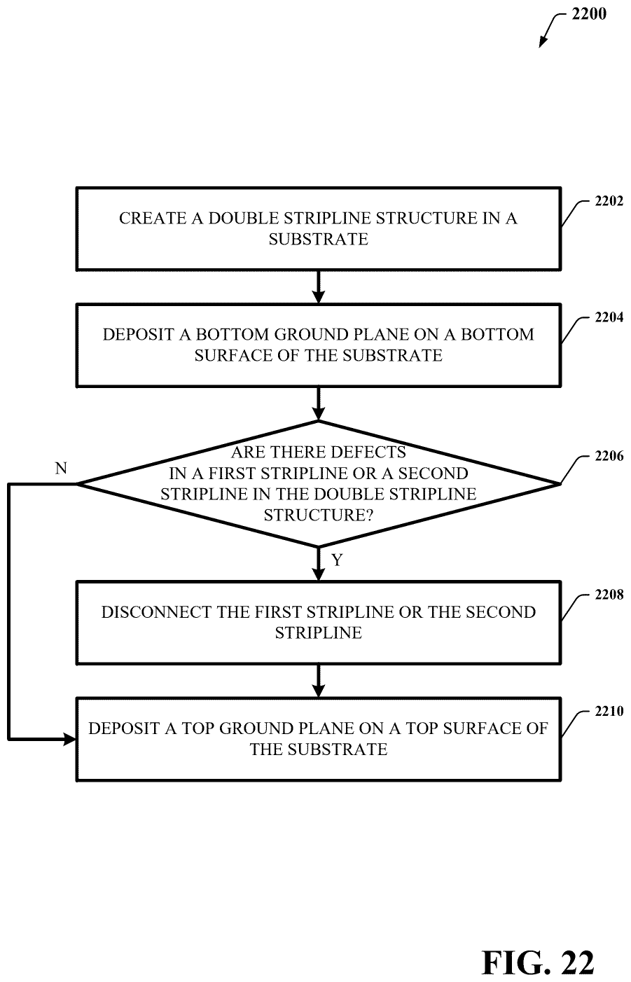

FIG. 22 illustrates a flow diagram of an example, non-limiting method 2200 for fabricating a superconductor ribbon cable structure with a double stripline structure in accordance with one or more embodiments described herein. Repetitive description of like elements and/or processes employed in respective embodiments is omitted for sake of brevity.

At 2202, the non-limiting method 2200 can comprise creating (e.g., via embossing, laser cutting, etching) a double stripline structure in a substrate. In various aspects

At 2204, the non-limiting method 2200 can comprise depositing a bottom ground plane on a bottom surface of the substrate.

Deposition is any process that grows, coats, or otherwise transfers a material onto a substrate. Available technologies include, but are not limited to, dielectric spin-on, thermal oxidation, physical vapor deposition (PVD), chemical vapor deposition (CVD), electrochemical deposition (ECD), molecular beam epitaxy (MBE), or atomic layer deposition (ALD) among others.

In some embodiments, patterning can be performed after deposition of the top ground plane or the bottom ground plane (e.g., top ground plane 102, bottom ground plane 104). As discussed in one or more embodiments herein, patterning is the shaping or altering of deposited materials, and is generally referred to as lithography. For example, in conventional lithography, the wafer is coated with a chemical called a photoresist; then, a machine called a stepper focuses, aligns, and moves a mask, exposing select portions of the wafer below to short wavelength light. The exposed regions are then washed away by a developer solution. After etching or other processing, the remaining photoresist is removed. After transferring the pattern, the patterned photoresist is removed utilizing resist stripping processes, such as wet chemical clean or ashing. Ashing can be used to remove a photoresist material, amorphous carbon, or organic planarization (OPL) layer. Ashing is performed using a suitable reaction gas, for example, O₂, N₂, H₂/N₂, O₃, CF₄, or any combination thereof. Patterning also includes electron-beam lithography, nanoimprint lithography, and reactive ion etching.

For example, after top ground plane 102 is deposited, patterning can be performed to define and create a desired pattern for the top ground plane 102 that can be etched to remove excess material. Etching is any process that selectively removes material on a deposited material to define a geometry of the material for subsequent cable fabrication steps.

At 2206, the non-limiting method 2200 can comprise determining if there are defects in a first stripline or a second stripline in the double stripline structure. If yes (e.g., there are defects in a first stripline or a second stripline in the double stripline structure), the non-limiting method 2200 can proceed to 2208. If no (e.g., there are no defects in a first stripline or a second stripline in the double stripline structure), the non-limiting method 2200 can proceed to 2210. In various aspects, one or more defects in the first stripline or the second stripline can be identified by optical inspection or electrical resistance testing of the double stripline structure. In cases for employing laser cutting to disconnect the first stripline or the second stripline, the double stripline structure (e.g., the signal layer) should be exposed. That is, optical inspection or electrical resistance testing of the double stripline structure can be performed so long as the double stripline structure is exposed, and thus, laser cutting can be performed to disconnect the first stripline or the second stripline when the double stripline structure is exposed.

At 2208, the non-limiting method 2200 can comprise disconnecting the first stripline or the second stripline. In various aspects, the first stripline or the second stripline can be disconnected by cutting each end of the first stripline or the second stripline. Specifically, if there is a defect in the first stripline, each end of the first stripline can be cut. Alternatively, if there is a defect in the second stripline, each end of the second stripline can be cut. In various instances, the first stripline or the second stripline can be cut via a laser cut, a mechanical cut, or an electrical cut.

At 2210, the non-limiting method 2200 can comprise depositing a top ground plane on a top surface of the substrate.

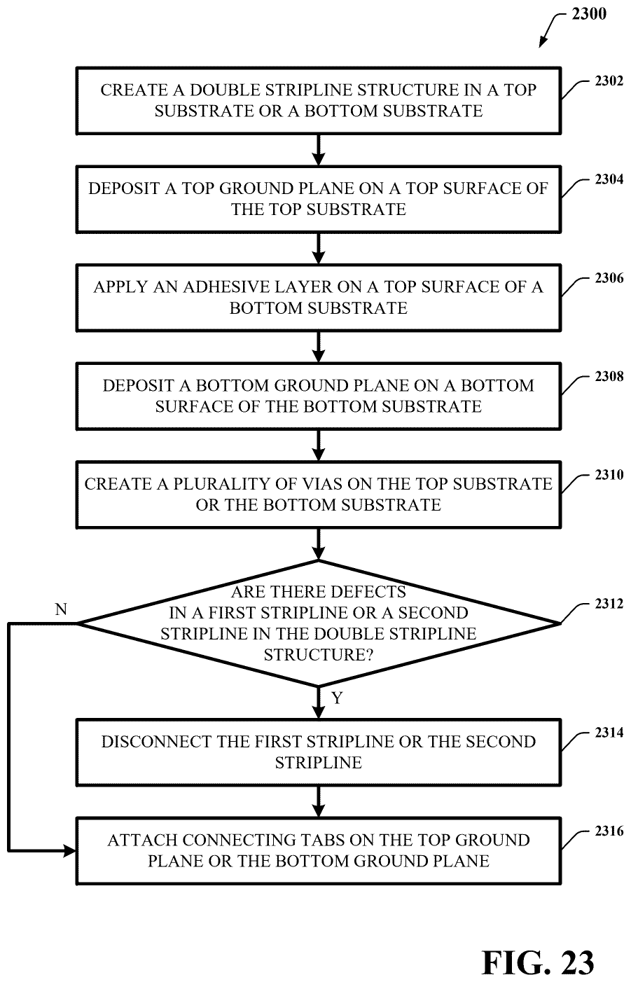

FIG. 23 illustrates a flow diagram of an example, non-limiting method 2300 fabricating a superconductor ribbon cable structure with a double stripline structure in accordance with one or more embodiments described herein. Repetitive description of like elements and/or processes employed in respective embodiments is omitted for sake of brevity. Repetitive description of like elements and/or processes employed in respective embodiments is omitted for sake of brevity.

At 2302, the non-limiting method 2300 can comprise creating (e.g., via embossing, laser cutting, etching) a double stripline structure in a top substrate or a bottom substrate.

At 2304, the non-limiting method 2300 can comprise depositing a top ground plane on a top surface of the top substrate.

At 2306, the non-limiting method 2300 can comprise applying an adhesive layer on a top surface of a bottom substrate.

At 2308, the non-limiting method 2300 can comprise depositing a bottom ground plane on a bottom surface of the bottom substrate.

At 2310, the non-limiting method 2300 can comprise creating a plurality of vias on the top substrate or the bottom substrate.

At 2312, the non-limiting method 2300 can comprise determining if there are defects in a first stripline or a second stripline in the double stripline structure. If yes (e.g., there are defects in a first stripline or a second stripline in the double stripline structure), the non-limiting method 2300 can proceed to 1914. If no (e.g., there are no defects in a first stripline or a second stripline in the double stripline structure), the non-limiting method 2300 can proceed to 1916. In various aspects, one or more defects in the first stripline or the second stripline can be identified by optical inspection or electrical resistance testing of the double stripline structure. In cases for employing laser cutting to disconnect the first stripline or the second stripline, the double stripline structure (e.g., the signal layer) should be exposed. That is, optical installation or electrical resistance testing of the double stripline structure can be performed so long as the double stripline structure is exposed, and thus, laser cutting can be performed to disconnect the first stripline or the second stripline when the double stripline structure is exposed.

At 2314, the non-limiting method 2300 can comprise disconnecting the first stripline or the second stripline.

At 2316, the non-limiting method 2300 can comprise attaching connecting tabs on the top ground plane or the bottom ground plane.

In some embodiments, stacking, bonding, or curing can be performed after any step in the fabrication process (e.g., after any step in the non-limiting methods 2200 or 2300). These processes can assemble or adhere different layers of the superconductor ribbon cable structure to each other. For example, thermal bonding can be performed to join the top substrate or the bottom substrate with the adhesive layer by applying heat or pressure. As another example, adhesive bonding can be performed to join layers by applying an adhesive that can be formed by curing at room temperature or applying additional heat. As yet another example, lamination can be performed to combine layers by applying heat and pressure to form a cohesive, multi-layered structure (e.g., to stack the top substrate and the bottom substrate for forming the fabricated superconductor flexible ribbon cable). As still another example, ultraviolet (UV) curing can be performed to cure or harder the adhesive later.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

It is, of course, not possible to describe every conceivable combination of methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A superconductor ribbon cable structure, comprising:
a top ground plane and a bottom ground plane;
a core substrate between the top ground plane and the bottom ground plane; and
a double stripline structure in the core substrate, the double stripline structure comprising:
a first stripline and a second stripline, wherein the second stripline is a floating stripline.

2. The superconductor ribbon cable structure of claim 1, wherein the double stripline structure comprises a side-by-side configuration, wherein the first stripline and the second stripline are in the core substrate.

3. The superconductor ribbon cable structure of claim 1, further comprising:
an adhesive layer in the core substrate, wherein the first stripline and the second stripline are on the adhesive layer.

4. The superconductor ribbon cable structure of claim 1, wherein the superconductor ribbon cable structure is a flex ribbon cable.

5. The superconductor ribbon cable structure of claim 1, wherein the double stripline structure comprises a plurality of floating striplines.

6. A superconductor ribbon cable structure, comprising:
a top ground plane and a bottom ground plane;
a substrate between the top ground plane and the bottom ground plane;
a double stripline structure on the substrate, the double stripline structure comprising:
a first stripline and a second stripline, wherein the second stripline is a floating stripline; and
a connecting tab on each end of the double stripline structure that connects the first stripline.

7. The superconductor ribbon cable structure of claim 5, wherein the substrate comprises a top substrate and a bottom substrate.

8. The superconductor ribbon cable structure of claim 7, wherein the double stripline structure comprises a side-by-side configuration, wherein the first stripline and the second stripline are on a bottom surface of the top substrate.

9. The superconductor ribbon cable structure of claim 8, wherein the connecting tab on each end of the double stripline structure is in the top ground plane or in the bottom ground plane.

10. The superconductor ribbon cable structure of claim 5, further comprising:
a plurality of vias that connect the substrate, the first stripline, the second stripline, or the connecting tab on each end of the double stripline structure.

11. The superconductor ribbon cable structure of claim 7, further comprising:
an adhesive layer that attaches the top substrate and the bottom substrate.

12. The superconductor ribbon cable structure of claim 7, wherein the double stripline structure comprises an up-down configuration, wherein the first stripline is on a bottom surface of the top substrate, and wherein the second stripline is on a top surface of the bottom substrate.

13. The superconductor ribbon cable structure of claim 12, wherein the connecting tab on each end of the double stripline structure comprises:
a connecting tab in the top ground plane; and
a connecting tab in the bottom ground plane.

14. The superconductor ribbon cable structure of claim 6, wherein the superconductor ribbon cable structure is a flex ribbon cable.

15. The superconductor ribbon cable structure of claim 6, wherein the double stripline structure comprises a plurality of floating striplines.

16. A method, comprising:
creating a double stripline structure in a substrate, the double stripline structure comprising:
a first stripline and a second stripline that are connected at each end of the double stripline structure;
depositing a bottom ground plane on a bottom surface of the substrate;
disconnecting the first stripline or the second stripline in response to a defect in the first stripline or the second stripline; and
depositing a top ground plane on a top surface of the substrate.

17. The method of claim 16, wherein disconnecting the first stripline or the second stripline comprises:
removing a portion of each end of the first stripline; or
removing a portion of each end of the second stripline.

18. The method of claim 16, further comprising:
attaching connecting tabs on the top ground plane or the bottom ground plane, wherein disconnecting the first stripline or the second stripline comprises:
removing a portion of the connecting tab on each end of the double stripline structure.

19. The method of claim 16, further comprising:
disconnecting the first stripline or the second stripline by laser cutting, mechanical cutting, or electrical cutting.

20. The method of claim 16, wherein the double stripline structure comprises a plurality of striplines that are connected at each end of the double stripline structure, further comprising:
disconnecting the plurality of striplines.
